(19) United States
(12) Patent Application Publication
(10) Pub. No.: US 2016/0348201 A1
(43) Pub. Date: Dec. 1, 2016

(54) IN-LINE METHOD AND IN-LINE PRODUCTION PLANT

(71) Applicant: STIWA HOLDING GMBH, Attnang-Puchheim (AT)

(72) Inventors: Klaus GRAUSGRUBER, Breitenschuetzing (AT); Michael THALER, Voecklabruck (AT)

(73) Assignee: STIWA Holding GmbH, Attnang-Puchheim (AT)

(21) Appl. No.: 15/036,474

(22) PCT Filed: Nov. 13, 2014
(86) PCT No.: PCT/AT2014/050272

§ 371 Date: Jul. 26, 2016

(30) Foreign Application Priority Data
Nov. 15, 2013 (AT) A 50761/2013

(51) Int. Cl. C21D 9/00; B23Q 7/14; C21D 11/00; B23K 31/02; C21D 1/09; C21D 1/18

(52) U.S. Cl. CPC C21D 9/0068; C21D 1/09; C21D 1/18; C21D 11/00; B23K 31/02; B23Q 7/14

(57) ABSTRACT

The invention relates to an in-line method for producing workpieces or assemblies (2), in which method the workpieces or assemblies (2) pass through a number of successive workstations (4) by means of a conveyor device (3). Said method is characterised by a hardening step that is carried out in one of the workstations (4), during which step at least one region of the workpiece or assembly (2) is hardened by the application of at least one laser hardening trace (6) by means of a laser device (5), in particular, a laser with programmable focusing optics (PFO) or a linear laser. The invention also relates to a corresponding in-line production plant.

The invention relates to an in-line method for producing workpieces or assemblies, in which method the workpieces or assemblies pass through several successive workstations by means of a conveyor device, and also relates to a corresponding in-line production plant.

In-line methods are highly automated processes, in which workpieces or assemblies pass through one by one a number of workstations. Such processes can be continuous or synchronised processes which run fully automatically and require intervention by an operator only in case of faults. In-line processes are characterised by a high production rate and an essentially constant processing quality.

Solutions for hardening the workpieees are known from another field in the state of the art. For instance, a reference is made to the following printed documents: DE10330068A1, DE3718647C1 as well as the report by J. Aichinger and D. Schuöcker: “Erhöhung der Biegesteifigkeit von Baustahl S235 (ST37) dureh selektives Härten mit Diodenlaser” (Fachlicher Bericht über die Subvention 2009) (“Increasing the bending stiffness of construction steel S235 (ST37) through selective hardening using diode lasers (technical report on the subsidy 2009)). In the state of the art, the laser hardening represents a method which is separate from other processing steps.

In-line method, according to the state of the-art, mostly refer to a limited sequence of processing steps, but such processes are notable to produce a workpiece from scratch. Therefore, important processing steps must already have been completed before the workpiece can be fed into the in-line process at all. As a result of this, on the one hand, the total processing time of the workpieces becomes very long, on the other hand, the space requirement for subjecting a workpiece to several successive processing steps becomes very high.

The aim of the invention is to eliminate these disadvantages and to provide an in-line method, with which not only are the processing options extended, but the processing time can also be reduced considerably. The reliability and the quality of the processing are to be ensured as also a reduction in the production costs is to be achieved.

This objective is achieved with an in-line method of the type mentioned at the beginning, by a hardening step, that is carried out in one of the workstations, during which step at least one region of the workpiece or of the assembly is hardened by the application of at least one laser hardening trace by means of a laser device, in particular a laser with programmable focusing optics (PFO) or a linear laser.

The combination or integration of a hardening step done through application of at least one laser hardening trace with or into an in-line method enables a considerable reduction of the cycle times. In addition, it is no longer necessary to harden the workpiece separately from the in-line process; this results in reduction of effort as well as saving of space. Even the (intermediate) storage of hardened workpicees before their further processing is eliminated. A key advantage is in the reduction of power consumption, which results on the one hand from the targeted hardening of only one area, and on the other hand, through the integration into the in-line method.

In-line method is understood as an automated process, in which the workpieces or assemblies pass through one by one a number of workstations and are subjected to a processing and/or a testing in these stations. An in-line method essentially corresponds to a fully automated production line, in which the transportation of the workpieces is also automated. The conveyor device(s), with which the workpieces are transported from one workstation to the next, as also the processing steps are controlled by a control unit in the individual workstations.

A preferred embodiment is characterised in that during and/or after the application of at least one laser hardening trace, the work hardness of one region of the workpiece or the assembly is set by controlling the laser device.

The work hardness can be set through a specific selection of parameters, especially by varying the laser power during the application of laser hardening trace or in a (immediately) following, at least time-offset process (tempering step), which may include application of farther laser hardening traces. In the first case, it is conceivable that the laser power varies constantly from a level which is necessary for hardening, to a level, which is necessary for tempering. In this case, the tempering step is integrated in the hardening step. The result of this is that a first place (point, spot) of the workpiece is already hardened and tempered, whereas an adjacent second place is not yet hardened or has not yet come in contact with the laser beam.

The work hardness represents the hardness which the finished product has when it is used. The desired hardness or the hardness profile in the workpiece (penetration depth, hardness parameter, e.g. 60 HRC) can be achieved during hardening of, for instance, steels that can be hardened based on distances, angles, laser power, feed rate of the laser head variably following the contour using different optics models.

At the same time, the work hardness can also be set. Alternatively, through a chronologically subsequent tempering, the hardness of the workpiece can be set, which is the same as a tempering treatment downstream to the hardening process. The tempering improves the component properties (e.g. toughness of teeth of a toothed rod) through relaxation of the brittle, martensitic structure within the material. Moreover, the gradual hardness profile from the outside to the inside has a positive influence on the component properties.

A preferred embodiment is characterised in that the work hardness of one region of the workpiece or the assembly is set through a separate tempering step, whereby the tempering step and the hardening step are carried out in the same workstation.

A preferred embodiment is characterised by a compensation step, in which, for compensating the warping expected or caused by laser hardening, the application of at least one more laser hardening trace is done at a different place of the workpiece or the assembly. Due to the compensation hardening trace(s) there is a stretching of the workpiece in the opposite direction, as a result of which the warping is compensated subsequently or does not occur at all in case of simultaneous application. Because of this measure it is no longer necessary to compensate for the warping by carrying out mechanical rework steps e.g. milling, electrical discharge machining, etc. or a straightening process (e.g. using hammers). The target geometry of the workpiece should be restored through the compensating laser hardening trace(s) in an easy and time-saving manner. The compensation can be done through a single or several uniformly distributed hardening traces. The compensation hardening traces can be applied on sides of the workpiece facing away from or lying opposite to the side having the actual hardening trace of the hardening step.

In the context of the in-line method the compensation step can be set back to the geometric target-starting position in the same or in one of the successive workstations (modules) with the same or with a different laser device (laser head). It is also conceivable that the compensation step is undertaken simultaneously with the hardening step.

A preferred embodiment is characterised in that the application of at least one laser hardening trace as per the hardening step and the application of at least one more laser hardening trace as per the compensation step is done by moving a laser spot along a specified trace, whereby the direction of movement of the laser spot during the hardening step is opposite to the direction of movement of the laser spot during the compensation step. This measure saves further processing time, since the laser need not be brought back to its starting position, before it can start with the compensation step.

A preferred embodiment is characterised in that the hardening step and the compensation step are carried out in the same workstation. This can further reduce the cycle times. The in-line production plant is simplified, occupies less space and becomes more economical.

A preferred embodiment is characterised in that the workpiece or the assembly and the laser device are moved relative to each other, preferably rotated around at least one rotary axis, between the hardening step and the compensation step. This measure enables, on the one hand, the use of the same laser device for the hardening step and for the compensation step and also simplifies the application of several hardening traces, which lie at different places of the workpiece. In doing so, the laser device can remain stationary and the workpiece or the assembly can be moved, in particular, rotated at least around one rotary axis, or the workpiece or the assembly remains stationary and the laser device is moved. In the first case, as part of the movement unit, a holding device can hold the workpiece or the assembly with a gripper or a clamp. Grippers or clamps are then rotated together with the workpiece around a corresponding rotary axis. The workpiece can be rotated by about 180° so that the compensating hardening trace can be applied at the opposite side. Other angles of rotation are also possible, mainly when several traces are to be applied respectively in different rotating positions.

A preferred embodiment is characterised in that a mechanical processing of the workpiece or of the assembly, in particular, cutting to length and/or milling, is done in one workstation following the workstation carrying out the laser hardening. This can provide a complete processing sequence, encompassing a thermal (hardening, compensation and/or tempering) and mechanical processing.

A preferred embodiment is characterised in that the application of at least one laser hardening trace is controlled by a control unit by applying process parameters, in particular, feed rate of the laser beam, laser power, distance between laser processing head and workpiece or assembly, angle, at which the laser beam falls on the workpiece or the assembly, whereby preferably the process parameters are regulated in real time. This ensures the quality and the reproducibility of the processing and the complete control of the process flows can be taken over by the control unit of the entire in-line process. In addition to the parameters, as mentioned above, optionally or additionally, a further support or influencing of the process can be done with further process parameters such as cooling of the workpiece or the component by means of various media, such as air, water, oil, etc. Preferably, the process parameters are regulated in real time together with the application of the laser beam and are adapted to the in-line process.

For instance, the cooling phase along the hardening trace can be regulated through the feed rate and/or the energy input (laser power). A high feed rate of the laser spot on the workpiece causes a high hardness of the region of the workpiece. A slow feed rate with a high energy input causes a spatially wider heat distribution in the workpiece, which ensures that the centre area of this heat distribution cools down only slowly, which is the same as the process of tempering in this specific area and leads to a higher toughness.

A preferred embodiment is characterised in that the process parameters are regulated depending upon the sensor data, which are recorded by at least one sensor in the workstation. For instance, the sensors can measure the extent of hardening distortion (during the hardening step). Depending upon the sensors, the compensation step, in particular, the position, contour, width, number of compensation hardening traces as well as the laser power applied, can be planned and carried out.

A preferred embodiment is characterised in that the hardening step and/or the tempering step and/or the compensation step are carried out under protective cover (process partitioning) having one or more parts, wherein preferably at least one part of the protective cover is movable. The protective cover is controlled preferably by a drive, which is connected to the control unit of the in-line production plant and is controlled by it. By using the protective cover, e.g. in the form of a protective hood, a defined process environment can be achieved. Thus, for instance, temperature, air humidity, light conditions can be set according to need. Even the introduction of process gases in the work space surrounded by the protective cover becomes possible through this. The movable design of the protective cover or a part thereof enables the conveying of the workpiece in the work space of the workstation with subsequent optimum shielding of the work space by moving the protective cover or a part thereof also in the conveying path.

Even a cooling device, e.g. in form of a cooling sprinkler, with which a cooling medium (like air, water, etc.) can be directed at, through or below the component, is conceivable and preferred in the hardening station.

The objective is also achieved with an in-line production plant for production of workpieces or assemblies, with a control unit, several successive workstations and a conveyor device, with which the workpieces or assemblies can be transported between the individual workstations, whereby one workstation is a hardening station and includes a laser device, which is set up to harden at least one region of a workpiece and/or assembly present in the workstation by applying at least one hardening trace.

A preferred embodiment is characterised in that the control unit for carrying out an in-line method is set up according to one of the embodiments described above.

A preferred embodiment is characterised in that the hardening station has a movement unit, which is designed to move the workpiece or the assembly and the laser device relative to each other, and preferably the movement unit is a rotating device with at least one rotary axis for relative rotation of workpiece or assembly and laser device. The movement unit may include a holding device e.g. at least one gripper or clamp, which holds the workpiece or the assembly during the movement or the rotation process.

A preferred embodiment is characterised in that the rotary axis is transverse to the direction of rotation, preferably located essentially normal to the direction of conveying of the conveyor device in the area of the hardening station. This enables a space-saving arrangement of the movement unit (together with holding device, where applicable) outside of the conveying path. Solutions with a rotary axis parallel to the direction of conveying are of course, not ruled out. E.g. a gripper or a clamp can travel in the conveying path, in order to hold the workpiece.

A preferred embodiment is characterised in that the hardening station includes a protective cover, having one or more parts, for the work space, and preferably the protective cover or a part of the protective cover is movable.

A preferred embodiment is characterised in that one of the workstations following the hardening station is a mechanical processing station, especially for cutting to length and/or milling the workpiece or the assembly.

A preferred embodiment is characterised in that the workstations following the hardening station include a welding station and/or a testing station and/or a labelling station and/or a mounting station and/or an oiling station and/or an output station.

The in-line method or the in-line production plant is suitable especially (but of course, not only) for elongated workpieces. The rotary axis, on which the workpiece is rotated between the hardening and the compensation step, could essentially be parallel to the longitudinal extension of the workpiece, which would require only minimum space in the hardening station.

For a better understanding of the invention, this is explained in detail with the help of the following figures.

The figures show in an extremely simplified, schematic display:

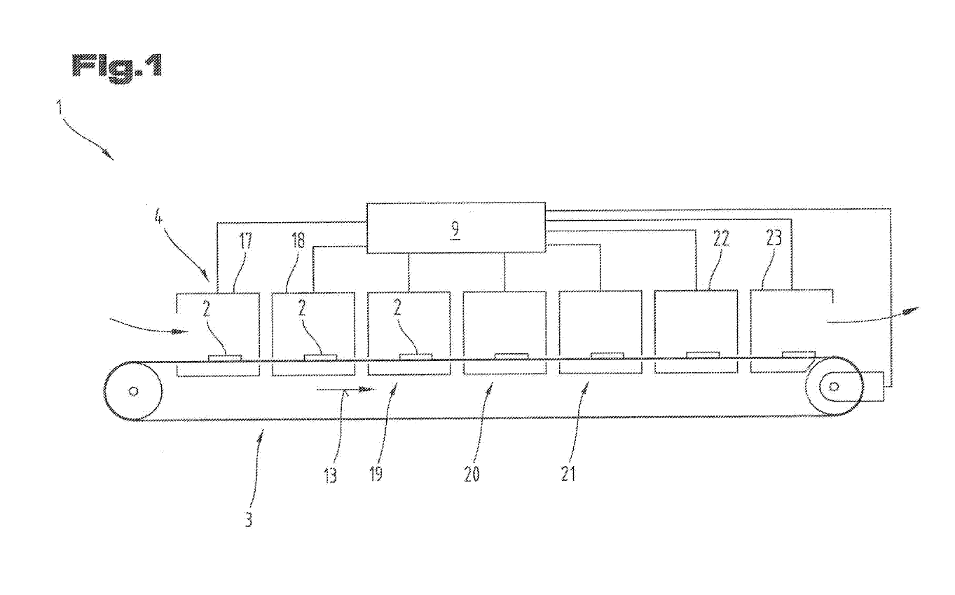

FIG. 1 schematic representation of an in-line production plant;

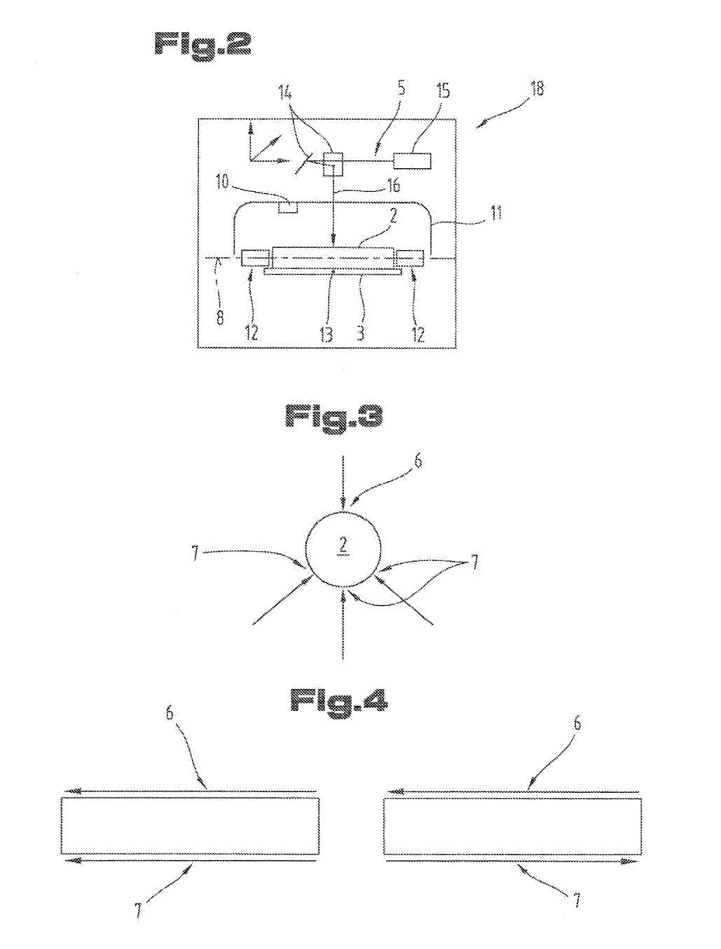

FIG. 2 a hardening station in detail and transverse to the direction of conveying of the conveyor device;

FIG. 3 a possible example for applying compensating laser hardening traces;

FIG. 4 two examples of directions of application;

FIG. 5 the temperature gradient at a point of the workpiece during a hardening step immediately followed by a tempering step;

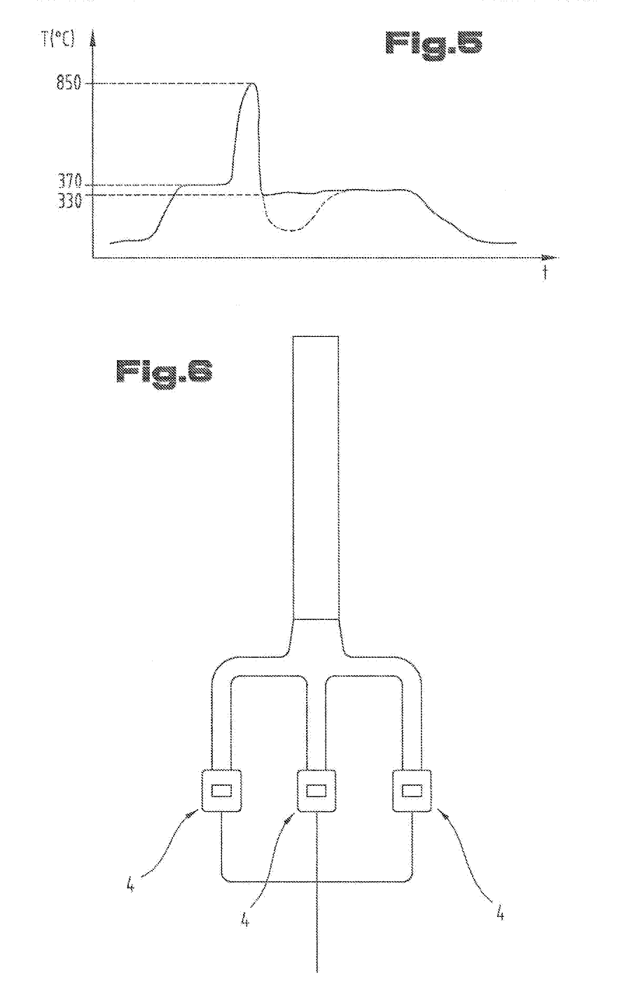

FIG. 6 an embodiment of the in-line method with parallel production lines.

At the outset it is mentioned here that same parts have been given the same reference signs or same component names in the different embodiments described, and the disclosures contained in the entire description can be applied analogously to same parts with same reference signs or same component names. Even the position specifications selected in the description, such as above, below, on the side, etc. refer essentially to the described and shown figure, and these position specifications can be applied analogously to the new position in case of a position change.

The embodiments show possible embodiment variants of the in-line method or of the in-line production plant, and it is noted at this point that the invention is not restricted to the especially shown embodiment variants of the same, but rather various combinations of the individual embodiment variants with each other are possible and this possibility of variation lies within the ability of a person skilled in the art working in this field based on the technical teaching of the present invention.

Furthermore, individual features or feature combinations of the different embodiments shown and described can represent independent, inventive solutions or solutions according to the invention.

The object underlying the independent, inventive solutions can be seen from the description.

Mainly, the individual embodiments shown in the figures constitute the object of the independent, inventive solutions. The relevant objects and solutions of the invention can be seen from the detailed descriptions of these figures.

As a matter of form, it is lastly pointed out that the invention or its components have partly been shown as not to scale and/or magnified and/or reduced in size for a better understanding.

FIG. 1 shows an in-line production plant 1 for production of workpieces or assemblies 2, with a control unit 9, several successive workstations 4 and a conveyor device 3, with which the workpieces or assemblies 2 are conveyed between the individual workstations 4, 17, . . . 23 in a direction of conveying 13. The conveyor device 3 can be implemented, for example, in the form of a running belt or a running chain. The control unit 9 is set up for carrying out an in-line method and controls the workstations 4 as well as the conveyor device 3. The arrow to the first workstation 17 (to the far left) indicates the loading of the in-line production plant 1. The arrow from the last workstation 23 (to the far right) indicates the removal of the finished parts.

One of the workstations 4 is a hardening station 18 and includes a laser device 5, which is set up to harden at least one region of a workpiece or an assembly 2 present in the workstation by applying at least one laser hardening trace 6.

FIG. 2 shows the hardening station 18 in detail with a laser device 5 consisting of a laser 15 and movable (i.e. can be rotated in the three spatial directions) mirrors 14, which deflect the laser beam 16 and move along a trace over the workpiece 2 (e.g. parallel to image plane of FIG. 2 ). Such laser devices are also known by the term: Laser with programmable focussing optics (PFO). In the preferred embodiment of FIG. 2 the hardening station 18 includes a movement unit 12, which is designed to move the workpiece or the assembly 2 and the laser device 5 relative to each other. In FIG. 2, the movement unit 12 is a rotating device with at least one rotary axis 8 for the relative rotation of workpiece or assembly 2 and laser device 5. The rotating device includes two clamps gripping the workpiece 2 on the sides, in order to fix the workpiece 2 during the rotating movements around the rotary axis 8. The rotary axis 8 of the rotating device is transverse, preferably essentially normal, to the direction of conveying 13 of the conveyor device 3 in the area of the hardening station 18.

A compensation step can now be carried out with this arrangement, in which, for compensating the warping expected or caused by the laser hardening, the application of at least one more laser hardening trace 7 is done at a different place of the workpiece or of the assembly 2. This situation is shown schematically in FIGS. 3 and 4.

Preferably, the application of at least one laser hardening trace 6 is done according to the hardening step and the application of one more laser hardening trace 7 according to the compensation step in each case by moving a laser spot along a specified trace, wherein the direction of movement of the laser spot (arrows in FIG. 4) during the hardening step and the direction of movement of the laser spot during the compensation step are opposite (upper part of FIG. 4). Alternatively, the directions of movement can also be in the same direction (lower part of FIG. 4). The resetting of the laser device 5 can be done, while the workpiece or the assembly 2 is moved or rotated to a different position. The workpiece or the assembly 2 and the laser device 5 are moved here relative to each other between the hardening step and the compensation step, preferably rotated at least around one rotary axis 8.

The application of several compensation hardening traces 7 at different places of the workpiece 2 is also possible. For this, FIG. 3 shows an example, and here the workpiece 2 is shown in cross-section and the laser beams as straight arrows. It is especially preferred, if the hardening step and the compensation step are done in the same workstation 4, i.e. in the hardening station 18.

The hardening station 18 can also include a protective cover 11 having one or more parts for the work area, and preferably, the protective cover 11 or a part of the protective cover 11 is movable.

The station before the hardening station 18 is a pick-up station 17 for picking up the workpieces or assemblies. The workstations following the hardening station 18 can include a mechanical processing station 19, especially for cutting to length and/or milling the workpiece or the assembly 2, a welding station 20, a testing station 21, an oiling station 22 and/or an output station 23. Further, mounting stations, labelling and/or cleaning stations would also be conceivable in the sequence of the production plant 1.

According to the in-line method for production of workpieces or assemblies 2, the workpieces or assemblies 2 pass through several successive workstations 4 by means of a conveyor device 3. In one of the workstations 4, the hardening station 18, a hardening step is now carried out, in which hardening is done at least in one region of the workpiece or of the assembly 2 by means of a laser device 5, in particular a laser with programmable focusing optics (PFO) or a linear laser, by using at least one laser hardening trace 6.

During and/or after the application of at least one laser hardening trace 6 the work hardness of a region of the workpiece or the assembly 2 can be set by controlling the laser device 5. This can be done in particular by controlling the laser power. FIG. 5 shows the temperature gradient for this. The hardening step is shown through the narrow peak (till 850° C.), whereas the process of tempering is described by the plateau (about 330° C.) that follows. In this phase, the laser power is reduced. In the illustration of FIG. 5 a pre-heating phase is also planned. However, this is optional.

The work of hardness in one region of the workpiece or of assembly 2 can also be set through a separate tempering step, and preferably the tempering step and the preceding hardening step are carried out in the same workstation, the hardening station 18.

The application of at least one laser hardening trace 6, 7 is done by means of a control unit 9 (FIG. 1) by applying process parameters, in particular feed rate of the laser beam, laser power, distance between laser processing head and workpiece or assembly 2, angle, at which the laser beam falls on the workpiece or on the assembly. In doing so, the process parameters are regulated preferably in real-time and/or depending upon sensor data, which are recorded at least through one sensor 10 in the relevant workstation 4. A sensor 10, which monitors the work space, is shown schematically in FIG. 2. Temperature sensors, optical sensors, in particular for determining the extent of hardening warpage, pressure, gas and/or flow sensors can be used as sensors.

FIG. 6 lastly shows that an in-line method can also include several parallel running lines, which can be merged together at a certain point of the process. Thus, each of the parallel lines can include a workstation 4, in particular, a hardening station. The workpieces hardened in this way are accepted in the further process and are either processed together and/or put together to make an assembly (mounting station). Through this nesting of the processes the cycle times can be reduced further; the production costs can also be reduced.

### LIST OF REFERENCE SIGNS

1 Production plant
2 Workpiece or assembly
3 Conveyor device
4 Workstation
5 Laser device
6 Laser hardening trace
7 compensating laser hardening trace
8 Rotary axis
9 Control unit
10 Sensor
11 Protective cover
12 Movement unit
13 Direction of conveying
14 Movable deflection mirror
15 Laser source
16 Laser beam
17 Input station
18 Hardening station
19 Mechanical processing station
20 Welding station
21 Testing station
22 Oiling station
23 Output station

1: In-line method for production of workpieces or assemblies (2), in which method the workpieces or assemblies (2) pass through a number of successive workstations (4) by means of a conveyor device (3), said method comprising a hardening step that is carried out in one of the workstations (4), during which step at least one region of the workpiece or assembly (2) is hardened by the application of a laser hardening trace (6) by means of a laser device (5), in particular, a laser with programmable focusing optics (PFO) or a linear laser.

2: In-line method according to claim 1, wherein during and/or after the application of at least one laser hardening trace (6), the work hardness of a region of the workpiece or assembly (2) is set by controlling the laser device (5).

3: In-line method according to claim 2, wherein the work hardness of a region of the workpiece or assembly (2) is set through a separate tempering step, and the tempering step and the hardening step are carried out in the same workstation (4).

4: In-line method according to claim 1, comprising a compensation step, in which for compensating the warping expected or caused by the laser hardening, the application of at least one more laser hardening trace (7) is done at a different place of the workpiece or the assembly (2)

5: In-line method according to claim 4, wherein the application of at least one laser hardening trace (6) according to the hardening step and the application of at least one more laser hardening trace (7) according to the compensation step is done by moving a laser spot along a specified trace, and the direction of movement of the laser spot during the hardening step is opposite to the direction of movement of the laser spot during the compensation step.

6: In-line method according to claim 4, wherein the hardening step and the compensation step are carried out in the same workstation (4).

7: In-line method according to claim 4, wherein the workpiece or the assembly (2) and the laser device (5) are moved relative to each other, preferably rotated around at least one rotary axis (8), between the hardening step and the compensation step.

8: In-line method according to claim 1, wherein in one workstation following the workstation (4) carrying out the laser hardening, a mechanical processing of the workpiece or assembly (2), in particular, cutting to length and/or milling, is done.

9: In-line method according to claim 1, wherein the application of at least one laser hardening trace (6, 7) is controlled by a control unit (9) by applying process parameters, in particular, feed rate of the laser beam, laser power, distance between laser processing head and workpiece or assembly (2), angle, at which the laser beam falls on the workpiece or the assembly, whereby preferably the process parameters are regulated in real time.

10: In-line method according to claim 9, wherein the process parameters are regulated depending upon sensor data, which are recorded by at least one sensor (10) in the workstation (4).

11: In-line method according to claim 1, wherein the hardening step and/or the tempering step and/or the compensation step are carried out under protective cover (11) having one or more parts, wherein preferably the protective cover (11) or a part of the protective cover (11) is movable.

12: In-line production plant (1) for production of workpieces or assemblies (2 ), with a control unit (9), several successive workstations (4) and a conveyor device (3), with which the workpieces or assemblies (2) can be conveyed between the individual workstations (4), wherein one workstation (4) is a hardening station and includes a laser device (5), which is set up for hardening at least one region of a workpiece or assembly (2) present in the workstation by applying at least one laser hardening trace (6).

13: In-line production plant according to claim 12, wherein the control unit (9) is set up for carrying out an in-line method.

14: In-line production plant according to claim 12, wherein the hardening station (4) has a movement unit (12), which is designed to move the workpiece or the assembly (2) and the laser device (5) relative to each, other, wherein preferably the movement unit (12) is a rotating device with at least one rotary axis (8) for relative rotation of workpiece or assembly (2) and laser device (5).

15: In-line production plant according to claim 14, wherein the rotary axis (8) of the rotating device is transverse, preferably essentially perpendicular, to the conveying direction of the conveyor device (3) in the area of the hardening station (4).

16: In-line production plant according to claim 12, wherein the hardening station includes a protective cover (11), having one or more parts, for the work space, wherein preferably the protective cover (11) or a part of the protective cover (11) is movable.

17: In-line production plant according to claim 12, wherein one of the workstations following the hardening station is a mechanical processing station, particularly for cutting to length and/or milling the workpiece or the assembly (2).

18: In-line production plant according to claim 12, wherein the workstations following the hardening station include a welding station and/or a testing station and/or a labelling station and/or a mounting station and/or an oiling station and/or an output station.
